(19) United States
(12) Patent Application Publication
(10) Pub. No.: US 2007/0125429 A1
(43) Pub. Date: Jun. 7, 2007

(54) Integrated leak detection and termination device for toilet

(76) Inventor: Philip Sanford Kandl, Union, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/589,274

(22) Filed: Oct. 26, 2006

Related U.S. Application Data
(60) Provisional application No. 60/742,453, filed on Dec. 5, 2005.

(51) Int. Cl. F16K 31/20

(52) U.S. Cl. 137/389

(57) ABSTRACT

A toilet fill valve assembly for filling a toilet tank with water includes a tube assembly sized and shaped so as to be mounted in the toilet tank and to receive a supply of water. The fill valve assembly also includes a fill valve, which is connected to the tube assembly and having an open state and closed state, and a float, which is coupled to the fill valve for moving the fill valve between the open and closed states. Moreover, a first sensor is coupled to at least one of the tube assembly and the float for detecting the position of the float, while a second sensor is coupled to the tube assembly for sensing water flow through the tube assembly. A controller is also coupled to the first sensor and the second sensor for receiving signals therefrom so as to determine whether a leak condition is present in the toilet tank. The tube assembly, the fill valve, the float, the first sensor, the second sensor and the controller are integrated with one another as a single unit.

### CROSS-REFERENCE TO RELATED APPLICATION

This application claims the benefit of U.S. Provisional Patent Application No. 60/742,453 filed Dec. 5, 2005, the entire disclosure of which is incorporated herein by reference in its entirety.

### FIELD OF THE INVENTION

The present invention relates to a leak detection and water flow termination device and, more particularly, to an integrated leak detection and termination device adapted for use in connection with a toilet.

### BACKGROUND OF THE INVENTION

A conventional toilet is typically equipped with a toilet tank and a fill valve which is adapted to restore the level of water in the toilet tank to a predetermined level after each flush. In situations where there is a small or large leak in the toilet tank caused, for instance, by an improperly positioned flapper valve, the toilet tank is continuously refilled with a supply of water. As a result, a large amount of water could be wasted if the leak is not detected and/or terminated relatively soon.

Efforts have been made in the past to develop devices for detecting leaks and/or terminating same by shutting off water flow to associated toilet tanks (see, for instance, U.S. Pat. Nos. 4,633,905, 5,125,120, 5,134,729, 5,979,372, 6,178,569, 6,058,519, 6,367,096, 6,671,893, 6,877,170, 6,934,977, 7,000,627, and 7,028,347; and U.S. Patent Application Publication Nos. 2003/0154542 and 2003/0145371). However, these devices still have various shortcomings and disadvantages. For example, some or all of these devices are provided with a fairly complicated construction and/or operation and are not adapted for easy installation.

### SUMMARY OF THE INVENTION

The present invention overcomes the disadvantages and shortcomings discussed above by providing a leak detection and termination device adapted for use in connection with a toilet tank. More particularly, the device includes a system for detecting and terminating relatively large and/or small leaks in the toilet tank and reacts to terminate such leaks by positively shutting off the water flow to same. The device can be integrated with a conventional fill valve as a one-piece unit, thereby facilitating its installation to, and removal from, the toilet tank.

In accordance with the present invention, a toilet fill valve assembly is provided for filling a toilet tank with water. More particularly, the fill valve assembly includes a tube assembly sized and shaped so as to be mounted in the toilet tank and to receive a supply of water. The fill valve assembly also includes a fill valve connected to the tube assembly and having an open state, in which the fill valve permits water to flow through the tube assembly so as to fill the toilet tank, and a closed state, in which the fill valve inhibits water from flowing through the tube assembly. A float is coupled to the fill valve for moving the fill valve between the open state and the closed state. The float is movable between a first position and a second position, which is lower than the first position. Moreover, a first sensor is coupled to at least one of the tube assembly and the float for detecting the position of the float, while a second sensor is coupled to the tube assembly for sensing water flow through the tube assembly. A controller is also coupled to the first sensor and the second sensor for receiving signals therefrom so as to determine whether a leak condition is present in the toilet tank. The tube assembly, the fill valve, the float, the first sensor, the second sensor and the controller are integrated with one another as a single unit.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a partially broken-away perspective view of a toilet tank assembly having a fill valve assembly which is equipped with a leak detection and termination device constructed in accordance with an exemplary embodiment of the present invention;

FIG. 2 is a side elevational view of the fill valve assembly shown in FIG. 1;

FIG. 3 is a top plan view of the fill valve assembly shown in FIG. 1;

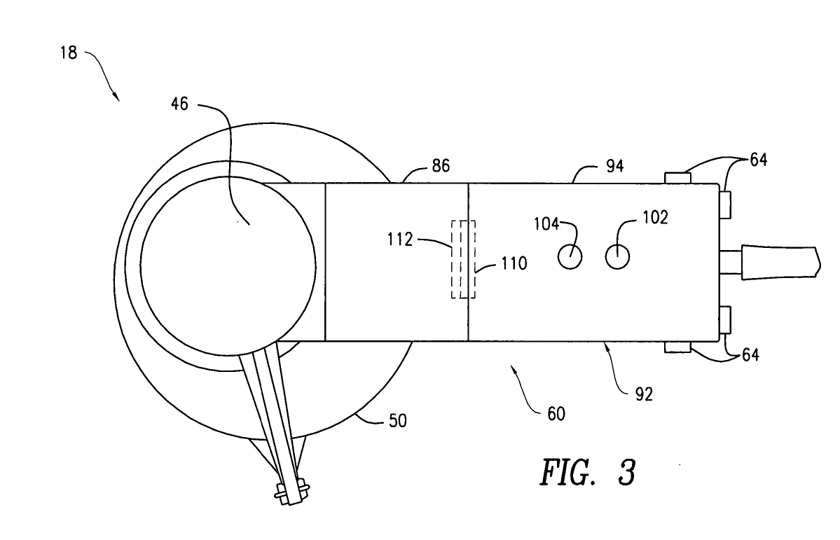

FIG. 4 is a cross-sectional view, taken along section line 4-4 and looking in the direction of the arrows, of the fill valve assembly shown in FIG. 2;

FIG. 5 is a schematic view of the leak detection and termination device shown in FIG. 1; and

FIG. 6 is a flow chart illustrating the operation of the leak detection and termination device shown in FIG. 5.

### DETAILED DESCRIPTION OF THE INVENTION

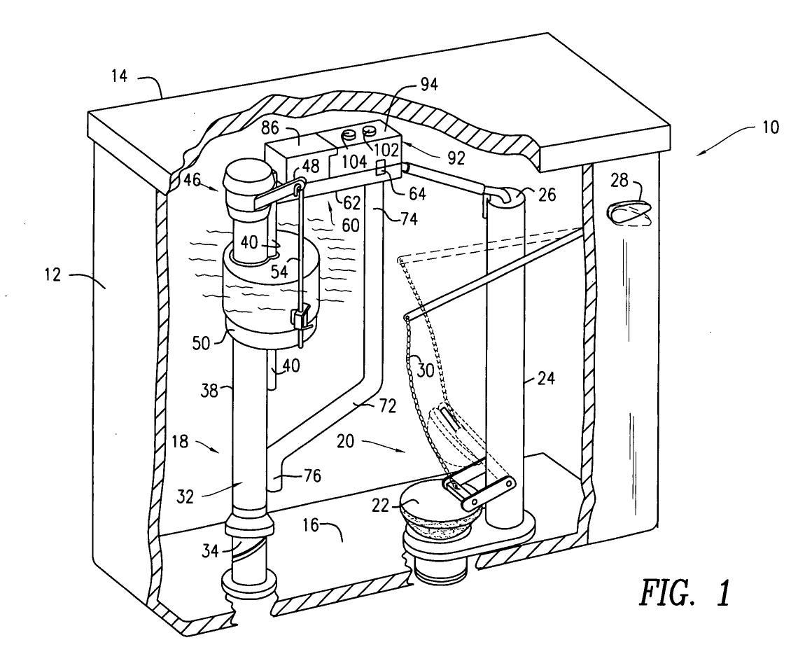

Referring to FIG. 1, there is shown a toilet tank assembly 10 having a tank 12 and a cover 14 removably placed thereon. The tank 12, which is adapted to contain a supply of water for selectively flushing a toilet bowel (not shown) connected thereto, includes a bottom wall 16. The toilet tank assembly 10 also includes a fill valve assembly 18 and an outflow valve assembly 20, both of which are mounted to the bottom wall 16 of the tank 12. The outflow valve assembly 20 is constructed and operates in a manner similar to that of a conventional outflow valve assembly. For instance, the outflow valve assembly 20 includes a flapper valve 22 for discharging a supply of water contained in the tank 12 to the toilet bowl. As a result, the flapper valve 22 is adapted to be moved between a closed position (see the solid line representation of same in FIG. 1) and an open position (see the broken line representation of same in FIG. 1). An overflow tube 24 is supported from the bottom wall 16 and includes an opening 26 extending therethrough for draining excess water from the tank 12, while a handle assembly 28 is pivotally attached to the tank 12. A chain or link 30 operatively interconnects the handle assembly 28 to the flapper valve 22 for moving the flapper valve 22 from its normally closed position to its open position in response to the pivotal movement of the handle assembly 28.

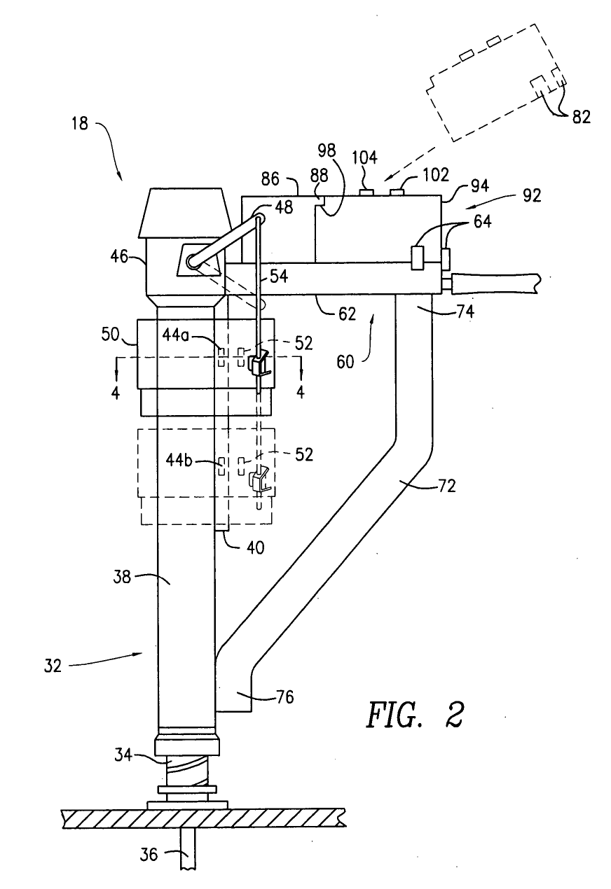

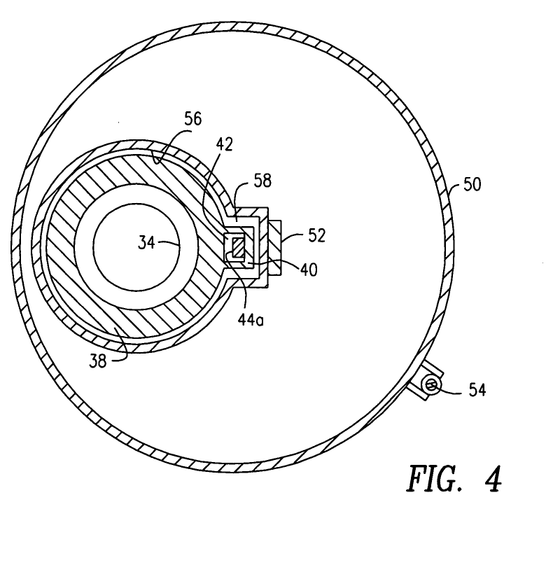

With reference to FIGS. 1 and 2, the fill valve assembly 18 includes a telescoping tube 32 which is supported from the bottom wall 16 of the tank 12. More particularly, the telescoping tube 32 has an inner tube 34, which is securely affixed to the bottom wall 16 of the tank 12 and is connected to a water supply tube 36 (see FIG. 2) for receiving a supply of water therefrom, and an outer tube 38, which is coupled to the inner tube 34. The outer tube 38 is movably attached to the inner tube 34 in a conventional manner such that the height of the telescoping tube 32 can be adjusted to a desired length when installing the fill valve assembly 18 in the tank 12. The outer tube 38 also includes an elongated housing 40 which projects radially outwardly therefrom and which extends substantially vertically. An internal, substantially liquid-tight chamber 42 (see FIG. 4) is formed within the housing 40, while upper and lower magnetic-type sensors 44a, 44b (see FIGS. 2, 4 and 5) are mounted within the chamber 42 such that they are spaced vertically from one another by a predetermined distance for purposes to be discussed hereinbelow.

Still referring to FIGS. 1 and 2, a fill valve 46, which has a construction and operation similar to those of a conventional fill valve, is fixedly attached to an upper end of the outer tube 38 for receiving a supply of water therefrom. A lever 48 is pivotally attached to the fill valve 46 for opening and closing the fill valve 46. The lever 48 is movable between an upper position (see the solid line representation of same in FIG. 2), in which the fill valve 46 is in its closed condition, and a lower position (see the broken line representation of same in FIG. 2), in which the fill valve 46 is in its open condition.

Now referring to FIGS. 2 and 4, the fill valve assembly 18 includes a float 50 which is movably mounted on the outer tube 38 and includes a magnet 52 attached thereto. More particularly, the float 50 is movable between an upper position (see the solid line representation of same in FIG. 2), in which the magnet 52 is substantially aligned with the upper sensor 44a, and a lower position (see the broken line representation of same in FIG. 2), in which the magnet 52 is aligned substantially with the lower sensor 44b. As will be discussed in greater detail hereinbelow, the upper and lower sensors 44a, 44b are adapted to detect the presence of a variety of leaks in the tank 12 caused, for instance, by the flapper valve 22 which is stuck in its open position.

A link 54 (see FIGS. 1 and 2) is pivotally attached to the lever 48 and is secured to the float 50 in a conventional manner for causing the lever 48 to move between its upper and lower positions in response to the movement of the float 50. As a result, when the float 50 is positioned in its upper position, the fill valve 46 is in its closed condition; when the float 50 is positioned in its lower position, the fill valve 46 is in its open condition. In order to permit movement along the outer tube 44, the float 50 is provided with an opening 56 (see FIG. 4) which slidably receives the outer tube 38. The opening 56 includes a channel 58 for accommodating the housing 40 therethrough.

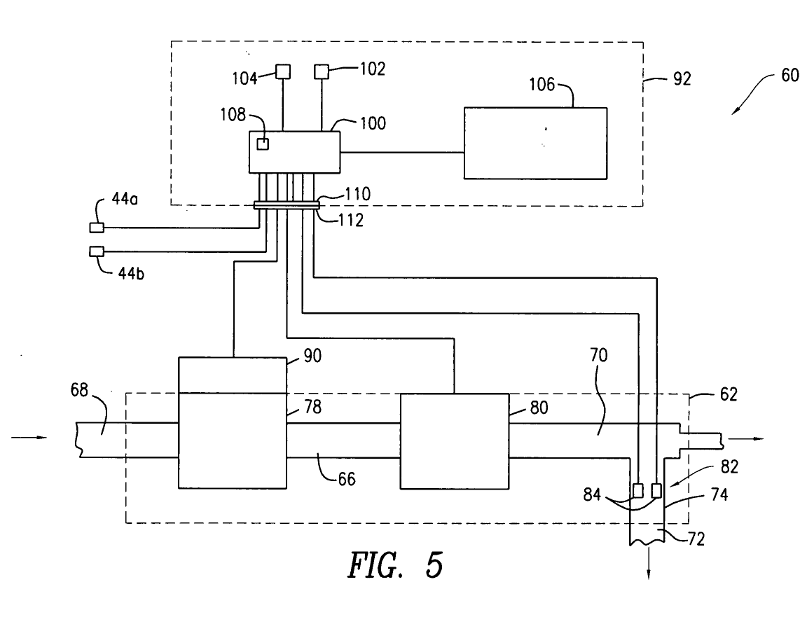

With reference to FIGS. 2 and 5, the fill valve assembly 18 is equipped with a leak detection and termination device 60 having a flow channel housing 62, which extends laterally outwardly from the fill valve 46 and which includes a plurality of resilient fingers 64 projecting therefrom for purposes to be discussed hereinbelow. The detection and termination device 60 is also equipped with a pipe 66 which is fluidly connected to the fill valve 46 at an upper stream end 68 thereof for receiving a supply of water from the fill valve 46 when the fill valve 46 is in its open condition. The pipe 66 extends through the channel housing 62 and terminates at a downstream end 70.

A discharge tube 72 is attached to the downstream end 70 of the pipe 66. More particularly, the discharge tube 72 extends through the channel housing 62 and includes an upper inlet end 74 which is connected to the downstream end 70 of the pipe 66. The discharge tube 72 projects downwardly from an outer end of the channel housing 62 and terminates at a lower discharge end 76 which is attached to the outer tube 38. The discharge tube 72 is made from a substantially rigid material so as to support the weight of the channel housing 62 and components supported thereby (discussed hereinbelow). The discharge tube 72 is adapted to receive a supply of water from the pipe 66 and discharge same into the tank 12 through the discharge end 76.

With continued reference to FIGS. 2 and 5, a termination valve 78 and an upstream flow sensor 80 are mounted in the channel housing 62. More particularly, the termination valve 78 is installed in the pipe 66 adjacent the upper stream end 68 for terminating a flow of water through the pipe 66, while the upstream flow sensor 80 is installed in the pipe 66 downstream from the termination valve 78 so as to detect water flowing through the pipe 66. The termination valve 78 can be any conventional type of fluid control valve adapted for moving between an open condition, in which it permits a water flow through the pipe 66, and a closed condition, in which it shuts off a water flow through same. For instance, the termination valve 78 can be in the form of a conventional normally open latching solenoid valve, which has low energy requirements. Other types of valves that can be used as the termination valve 78 include, without limitation, motorized ball valves and electrical pinch valves.

Similarly, the upstream flow sensor 80 can be in the form of any conventional metering sensor which can be used for determining the rate of water flowing through the pipe 66. For instance, a turbine or wheel-type flow sensor is suitable for use as the upstream flow sensor 80. This type of flow sensor can be adapted from a conventional design which includes a revolving impeller (or wheel) equipped with an impregnated permanent magnet and mounted in a fluid flow channel (e.g., the pipe 66). The sensor 80 can be a hall-effect or reed switch and can be mounted in a separate control module (described below herein) so as to be separate from the impeller and water passing through the pipe 66 (to thereby prevent water contamination). An electronic controller (described below herein) can be adapted to count the number of electrical pulses transmitted from the sensor 80 as the permanent magnet of the impeller passes by the sensor 80. In this manner, the upstream flow sensor 80 can be used to determine the rate of water flowing through the pipe 66 for metering the amount of water flowing into the tank 12 (which is a measure of the amount of water utilized per flush of the toilet).

The detection and termination device 60 is also provided with a downstream flow sensor 82 (see FIG. 5) which is positioned downstream from the upstream flow sensor 80. The downstream flow sensor 82 is adapted for sensing a flow of water through the discharge tube 72 and hence the pipe 66. More particularly, the downstream flow sensor 82 is provided with sufficient sensitivity so as to detect a relatively small amount of water flow through the discharge tube 72 and/or the pipe 66. In this regard, the downstream flow sensor 82 can preferably be a water conductivity sensor having exposed metal end electrodes 84 (e.g., exposed stainless steel wire contacts) which are separated from each other such that they can be electrically closed by water passing thereby and completing the circuit so as to electrically detect the presence of water positioned therebetween. Alternatively, other types of flow sensors adapted to perform the function discussed herein are suitable for use as the downstream flow sensor 82. The downstream flow sensor 82 is preferably mounted in the upper inlet end 74 (i.e., a substantially vertical portion) of the discharge tube 72. As a result, when water flow through the pipe 66 and/or the discharge tube 72 is terminated, the upper inlet end 74 is prevented from retaining any significant amount of water which would cause malfunctioning of the downstream flow sensor 82. As will be discussed in greater detail hereinbelow, each of the upstream and downstream flow sensors 80, 82 is adapted to detect a relatively small leak (i.e., a leak which is relatively small and/or slow in terms of amount and/or flow rate) in the tank 12 caused, for instance, by the flapper valve 22 improperly seated in a corresponding valve seat or fill valve 46 not closed completely.

The water conductivity circuit contains programming to ascertain the timing of water flowing by the downstream sensor 82, and implements a reversal of polarity to the electrodes to reduce build up of deposits that would affect sensitivity.

Still referring to FIGS. 2 and 5, the detection and termination device 60 is provided with an actuator housing 86 which is mounted on the channel housing 62 and which includes a lip 88 projecting laterally outwardly therefrom. A valve actuator 90 is housed within the actuator housing 86 and is coupled to the termination valve 78 for moving same between its open and closed conditions.

A control module 92 is removably attached to the channel housing 62 (see FIGS. 1, 2 and 5). More particularly, the control module 92 has a casing 94 which includes a plurality of recesses 96 and a notch 98 formed therein. The notch 98 is adapted to receive the lip 88 of the actuator housing 86, while each of the recesses 96 is sized and shaped so as to receive a corresponding one of the fingers 64 of the channel housing 62 in a releasably interlocking fashion. In this manner, the control module 92 can be attached to and/or removed from the channel housing 62 manually without the use of tools. For instance, the connection of the control module 92 to the channel housing 62 can be accomplished by first positioning the lip 88 in the notch 98 and then pressing an opposite end of the control module 92 downward such that the fingers 64 are releasably interlocked in the recesses 96.

Now referring primarily to FIG. 5, the control module 92 includes an electronic controller 100 having indicator lights 102 and a reset switch 104 which are mounted on the casing 94. A power supply unit 106 (e.g., one or more conventional batteries, such as three or four AA-type alkaline batteries) is also provided within the casing 94 and is connected to the controller 100 for providing electrical power thereto. The power supply unit 106 may include a recharging circuit utilizing a flux field emitted from the rotating turbine wheel of the upstream flow sensor 68. The controller 100, which preferably includes one or more conventional microprocessors and memories (not shown) for controlling the operation of the detection and termination device 60, is connected to the upper and lower sensors 44a, 44b and the upstream and downstream flow sensors 80, 82 for receiving input signals therefrom. The controller 100 is also connected to the valve actuator 90. The controller 100 includes one or more programs for processing input signals received from the upper and lower sensors 44a, 44b and the upstream and downstream flow sensors 80, 82 and for actuating the valve actuator 90 if certain predetermined conditions (to be discussed in greater detail hereinbelow) are detected by the controller 100. The controller 100 is also equipped with a timer 108 for purposes to be discussed below.

The control module 92 also includes a cable connector 110 (e.g., a pin-type connector) which is pre-wired to the controller 100. A cable connector 112 is also pre-wired to the upper and lower sensors 44a, 44b, the upstream and downstream flow sensors 80, 82 and the valve actuator 90 and is provided on the channel housing 62. The cable connector 112 is positioned and configured such that it can be automatically connected to the connector 110 in a proper manner when the control module 92 is manually coupled to the channel housing 62, thereby facilitating the electrical connection between the controller 100 and the upper and lower sensors 44a, 44b, the upstream and downstream flow sensors 80, 82 and the valve actuator 90. It should be noted that the control module 92 is separate from the channel housing 62 and this feature eliminates the possibility of leakage through the channel housing 62 and isolates electrical and electronic components contained in the control module 92 from possible water contamination.

Referring back to FIGS. 1 and 2, the fill valve assembly 18 is installed to the bottom wall 16 of the tank 12 in a manner similar to that of a conventional fill valve assembly. More particularly, the fill valve assembly 18 is installed to the tank 12 by attaching the inner tube 34 of the telescoping tube 32 to the bottom wall 16. Because the detection and termination device 60 is integrated with the fill valve assembly 18 as a single piece, its installation to the tank 12 is made simple and efficient.

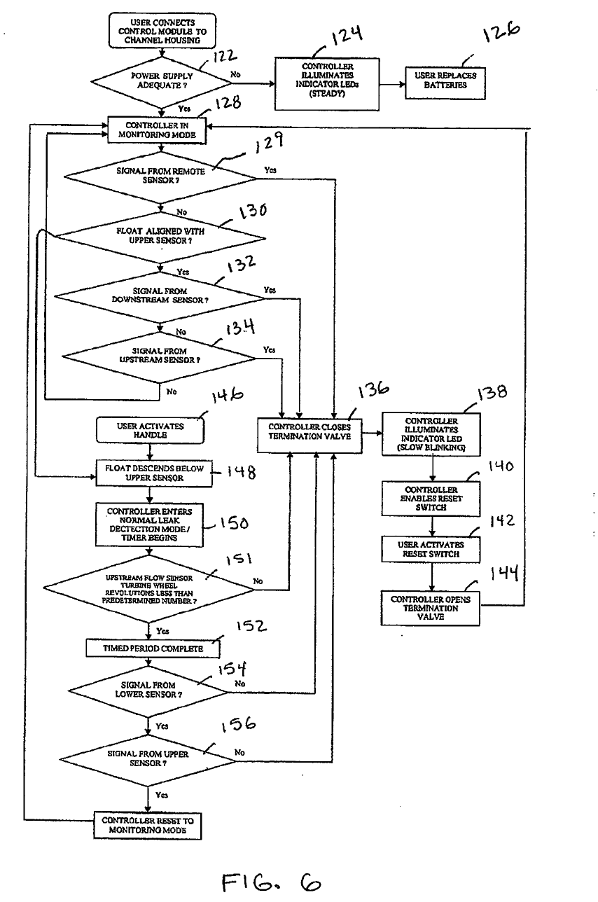

FIG. 6 illustrates a control logic utilized by the detection and termination device 60 for detecting and terminating water leaks from the tank 12. In this regard, it is noted that the detection and termination device 60 is especially adapted for detecting leaks caused by one or more of the following conditions: wearing and/or distortion of the flapper valve 22; obstruction preventing the flapper valve 22 from properly seating on its valve seat; the flapper valve 22 which is hung up (i.e., improperly adjusted); malfunctioning or improper adjustment of the float 50; incomplete closure of the fill valve 46 due to impurity build-up, etc.; and/or combinations thereof. Water leakage may also occur as a result of faulty, corroded, or misaligned connections between the bottom wall 16 and the fill valve assembly 18 and/or the outflow valve assembly 20, as well as between the tank 12 and the toilet bowl.

When the control module 92 is initially installed on the channel housing 62 by a user (see step 120 in FIG. 6), the controller 100 is electrically connected to the upper and lower sensors 44a, 44b, the upstream and downstream flow sensors 80, 82 and the valve actuator 90 via the cable connectors 110, 112. When detecting such connection, the controller 100 enters a power assessment mode, in which the adequacy of the power supply unit 106 is assessed by the controller 100 (see step 122). More particularly, if the power level of the power supply unit 106 is determined to be inadequate for the proper operation of the detection and termination device 60, the indicator LEDs 102 are illuminated (see step 124). When the power problem detected by the controller 100 is corrected by the user (for example by replacing the batteries) in step 126, the controller 100 again ascertains the adequacy of the power supply unit 106 and enters a monitoring mode at step 128 if the power supply unit 106 is deemed adequate.

To check condition of power supply unit 106, depressing reset switch, in non-tripped condition, completes battery check circuit and indicates status of the power supply unit 106 by the combination of three LEDs: green, amber, and red. The status of the power supply unit 106 will be indicated by:
full power—illumination of green, amber & red LEDs
partial power—illumination of combination of amber and red LEDs
inadequate power—illumination of red LED
no power—no LED illumination

Referring to step 128, the controller 100 continuously monitors the condition of the upper and lower sensors 44a, 44b and the upstream and downstream flow sensors 80, 82 by receiving and processing signals transmitted therefrom. More particularly, the position of the float 50 is checked by the controller 100 by processing signals received from the upper and/or lower sensors 44a, 44b. If the float 50 is not in its upper position (i.e., it is positioned below the upper sensor 44a), no signal is transmitted from same to the controller 100, indicating that the float 50 has moved toward its lower position and the tank 12 is in the process of being refilled with water after a flushing operation. As a result, the controller 100 enters a tank-refilling mode to be discussed hereinbelow. If, on the other hand, the float 50 is aligned with the upper sensor 44a, an appropriate signal is sent from the upper sensor 44a to the controller 100 (see step 130) to indicate that the float 50 is properly positioned in its upper position; wherein the tank is filled with water, and that there is no leakage in the tank 12 (e.g., the flapper valve 22 is properly positioned in its closed position).

If the controller 100 determines at step 130 that the float 50 is aligned with the upper sensor 44a, it then proceeds to sequentially check the condition of the upstream and downstream flow sensors 80, 82 (see steps 132 and 134, respectively). If no water flow through the pipe 66 and the discharge tube 72 is detected by the upstream flow sensor 80 and the downstream sensor 82, respectively, no signal is transmitted to the controller 100, thereby indicating that there is no leak in the tank 12 and the fill valve 46 is seated properly. As a result, the controller 100 returns to the monitoring mode of step 128.

If either one or both of the upstream and downstream flow sensors 80, 82 detects water flowing through the pipe 66 and/or the discharge tube 72 at step 132 or 134, an appropriate signal is transmitted therefrom to the controller 100. Since the float 50 is checked in step 130 to be in its upper position, any such water flow indicates that there is a relatively small leak in the tank 12 (e.g., a leak caused by the fill valve 46 not completely closed (not seated properly). In response, the controller 100 initiates a shut-off sequence by energizing the valve actuator 90 and moving the termination valve 78 from its open condition to its closed condition (see step 136), thereby terminating water flow through the pipe 66 and hence the discharge tube 72. As part of the shut-off sequence, the controller 100 illuminates the indicator light 102 in a preselected manner (e.g., blinking illuminated red LED) at step 138 to alert the user that there is a leak in the tank 12. The controller 100 also enables the reset switch 104 (see step 140) so that the controller 100 can be reset when the reset switch 104 is activated or actuated by the user. The termination valve 78 remains closed until the reset switch 104 is manually activated by the user. Once the cause of the leak is eliminated by the user and the reset switch 104 is activated (see step 142), the termination valve 78 is moved from its closed condition to its open condition (see step 144), thereby permitting water to flow through the pipe 66 and the discharge tube 72. After approximately a minute delay, the controller 100 then returns to its monitoring mode (see step 128).

The leak detection and termination system has available a manual override of the leak detection circuit to allow landlords, hotels and public facilities managers and end users the ability to maintain operation of the toilet fill valve 46 without leak detection. The override switch will be a magnetic switch (e.g. reed or hall effect) contained in the control module 92 that can be switched on and off when in close proximity to a permanent magnet. The manual override mode will be indicated by a slow blinking amber LED.

When the handle assembly 28 is pivoted by the user to initiate a flushing operation, the flapper valve 22 is moved from its closed position to its open position (see step 146), and water begins to rapidly discharge from the tank 12 through the outflow valve assembly 20. In response, the float 50 begins to descend from its upper position toward its lower position (see step 148), thereby causing the fill valve 46 to move from its closed condition to its open condition to refill the tank 12 with water. Because the magnet 52 of the float 50 becomes misaligned with the upper sensor 44a, the transmission of an input signal from the upper sensor 44a to the controller is terminated. In response, the controller 100 initiates the tank-refilling mode mentioned above (see step 150) by activating the timer 108 to monitor the refilling process for a predetermined refilling time period (e.g., a two minute period). During the duration of this time period, the controller 100 continuously monitors the amount of water flowing into the tank 12 such that if such an amount exceeds a maximum predetermined refill amount (calculated by the number of revolutions of the upstream flow sensor 80 turbine wheel revolutions, counted by the controller 100, that are equivalent to water flow quantity of 2 gallons), whereby the controller 100 illuminates the amber indicator LED (e.g. slow blinking). In this instance, the controller 100 initiates the shut-off sequence of steps 136, 138 and 140, wherein the termination valve 78 is closed until the user actuates the reset switch 104.

Referring back to step 151, if the controller 100 determines that the amount of water flowing into the tank 12 has not exceeded the predetermined refill amount within the predetermined time period, the controller 100 then proceeds to check whether input signals have been received from lower and upper sensors, 44a and 44b (see steps 154, 156).

Referring to step 152, if a predetermined refilling time period has elapsed, the controller 100 ascertains whether a signal is being received from the lower sensor 44b (i.e., whether the float 50 is positioned at its lower position and is aligned with the lower sensor 44b) (see step 154). The transmission of a signal from the lower sensor 44b at this point (i.e., after the lapse of the predetermined refilling time period) indicates that a relatively large leak (e.g., a leak caused by the flapper valve 22 which is stuck in its open position) is present in the tank 12. In response, the controller 100 initiates the shut-off sequence of steps 136, 138 and 140, wherein the termination valve 78 is closed until the user actuates the reset switch 104.

Referring back to step 154, if no signal is received from the lower sensor 44b, it indicates that the float 50 is located above the lower sensor 44b and may be hence ascending toward its upper position. The controller 100 then monitors the condition of the upper sensor 44a to determine whether the float 50 moves into its upper position. If the float 50 fails to move into its upper position (i.e., no signal is received from the upper sensor 44a) within a predetermined time period, such failure is indicative of a large leak present in the tank 12. As a result, the controller 100 initiates the shut-off sequence of steps 136, 138 and 140, wherein the termination valve 78 is in its closed condition until the reset switch 104 is activated to reset the controller 100 (see steps 142 and 144).

Referring back to step 148, once the tank refilling mode is initiated, the float 50 descends from its upper position, therefore magnet 52 no longer opposes upper sensor 44a, which consequently opens upper sensor circuit (no input signal). If the float 50 does not sequentially pass and thus activate the lower sensor 44b (i.e., an input signal is transmitted by lower sensor 44b to control 100) prior to the float 50 returning to the upper position, during the predetermined timed period, a leak typically in the flapper seal is detected. The controller 100 then initiates the shut-off sequence of steps 136, 138 & 140 wherein the termination valve 78 is closed until the user actuates the reset switch 104.

Referring to step 160, if after an input signal is received from the lower sensor 44b, the float 50 moves to its upper position within the predetermined time period, an input signal is transmitted from the upper sensor 44a to the controller 100, thereby indicating that the refilling of the tank 12 is completed. In response, after a 20 second delay, the controller 100 returns to the monitoring mode of step 128.

The present invention may also include a radio frequency (RF) receiver circuit in the control module 92 and a remote floor positioned water detection sensor coupled to the control module 92 with a RF transmitter. The remote sensor can be positioned on the floor, directly below the toilet tank assembly 10. In the event the remote sensor detects the presence of water, the remote sensor transmits a RF signal to controller 100 to indicate an error (toilet overflow) condition (see step 129), which causes the controller 100 to initiate the shut-off sequence of steps 136, 138, and 140, wherein the termination valve 78 is closed until the user actuates the reset switch 104.

It should be appreciated that the present invention provides numerous advantages over the prior art discussed above. For instance, the detection and termination device 60 of the present invention is adapted to detect and immediately terminate water leakage from the tank 12, regardless of the size of the leakage. Even minute, barely discernible leakages (for example as a result of a worn or corroded fill valve 46, flapper valve 22, bolts, connections, etc.) can be detected and terminated. In addition, the detection and termination device 60 also meters the quantity of water that flows into the tank 12, and indicates when such metered quantity of the water exceeds a predetermined amount.

Another advantage of the present invention is the retrofitability of the fill valve assembly 18, as it is insertable into and removable from the tank 12 as a one-piece unit. This feature is particularly useful for conveniently retrofitting installed conventional fill valve assemblies as well as replacing new installations of same.

Yet another feature of the present invention is the lack of adjustments or settings necessary to install and activate the fill valve assembly 18. The operation and control of the present invention are also simple, because the indicator light 102 signals a low power supply condition, a leak-detected condition, and a quantity of water that exceeds a predetermined-quantity condition. The modular design facilitates easy replacement of control module and convenient replacement of batteries without removal of the flow channel housing 62.

It should be noted that the present invention can have numerous variations and modifications. For instance, one of the flow sensors 80, 82 can be eliminated. In addition, each of the flow sensors 80, 82 can be replaced with a different type of flow sensor. Moreover, a different mechanism (e.g., a non-magnetic-type system) can be utilized for monitoring the position of the float 50. The inner and outer tubes 34, 38 of the telescoping tube 32 can be formed as a single piece. Further, the present invention can be used in connection with many different types of fluid handling apparatus. The valve actuator 90 may also be in the form of any valve actuator, including a latching solenoid. One or more of the steps illustrated in FIG. 6 may also be modified or eliminated.

It will be understood that the embodiment described herein is merely exemplary and that a person skilled in the art may make many variations and modifications without departing from the spirit and scope of the invention. All such variations and modifications, including those discussed above, are intended to be included within the scope of the invention as defined in the appended claims.

I claim:

1. A fill valve assembly for filling a toilet tank with water, comprising a tube assembly sized and shaped so as to be mounted in the toilet tank and to receive a supply of water; a fill valve connected to said tube assembly, said fill valve having an open state, in which said fill valve permits water to flow through said tube assembly so as to fill the toilet tank, and a closed state, in which said fill valve inhibits water from flowing through said tube assembly; a float coupled to said fill valve for moving said fill valve between said open state and said closed state, said float being movable between a first position and a second position, which is lower than said first position; a first sensor coupled to at least one of said tube assembly and said float for detecting the position of said float; a second sensor coupled to said tube assembly for sensing water flow through said tube assembly; and a controller coupled to said first sensor and said second sensor for receiving signals therefrom so as to determine whether a leak condition is present in the toilet tank, said tube assembly, said fill valve, said float, said first sensor, said second sensor and said controller being integrated with one another as a single unit.

2. The fill valve assembly according to claim 1, wherein said tube assembly includes a tube, said second sensor being positioned in said tube.

3. The fill valve assembly according to claim 2, wherein said second sensor includes a first flow sensor, which is positioned downstream in said tube, and a second flow sensor, which is positioned upstream in said tube.

4. The fill valve assembly according to claim 3, wherein said first flow sensor includes at least two electrodes which are in electrical contact when a supply of water flows through said tube.

5. The fill valve assembly according to claim 4, wherein said second flow sensor includes an impeller rotatably mounted with respect to said tube such that said impeller can rotate in response to water flowing through said tube.

6. The fill valve assembly according to claim 5, further comprising a power supply unit, said second flow sensor being capable of generating electricity in response to rotation of said impeller, said power supply unit being connected to said second flow sensor so as to receive the electricity therefrom.

7. The fill valve assembly of claim 5, wherein said second flow sensor is connected to said controller for calculating the rate of water flow through said tube assembly so as to meter the amount of water flowing into the toilet tank.

8. The fill valve assembly according to claim 1, wherein said tube assembly includes an intake tube which is sized and shaped so as to be mounted to the toilet tank and fluidly connected to said fill valve for conveying a supply of water thereto, said first sensor includes a first sensor part, which is mounted to said float, and at least one second sensor part, which is mounted to said intake tube.

9. The fill valve assembly according to claim 8, wherein said float is movably mounted to said intake tube such that said float is movable between said first and second positions.

10. The fill valve assembly according to claim 9, wherein said at least one second sensor part includes at least two second sensor parts which are spaced from each other in a generally vertical direction, said first sensor part being in at least partial alignment with one of said at least two second sensor parts when said float is in its said first position, said first sensor part being in at least partial alignment with the other one of said at least two second sensor parts when said float is in its said second position.

11. The fill valve assembly according to claim 8, wherein said tube assembly includes an output tube fluidly connected to said fill valve for receiving a supply of water therefrom, said second sensor being positioned in said output tube.

12. The fill valve assembly according to claim 11, wherein said second sensor includes a first flow sensor and a second flow sensor positioned in said output tube.

13. The fill valve assembly according to claim 1, further comprising a casing for housing said controller therein; and a termination valve mounted to a section of said tube assembly for inhibiting water flow through said tube assembly in response to said controller detecting the leak condition.

14. The fill valve assembly according to claim 13, further comprising a housing for housing said termination valve and said section of said tube assembly, said casing being removably attached to said housing such that said casing can be readily detached from said housing.

15. The fill valve assembly according to claim 14, wherein said second sensor is positioned in said section of said tube assembly, said section of said tube assembly being positioned downstream from said fill valve.

16. The fill valve assembly according to claim 15, wherein said tube assembly includes an intake tube, which is fluidly connected to said fill valve for conveying a supply of water thereto, and an output tube, which is fluidly connected to said fill valve for receiving a supply of water therefrom, said section of said tube assembly being a part of said output tube.

17. The fill valve assembly according to claim 13, further comprising indicating means attached to said casing for indicating the leak condition.

18. The fill valve assembly according to claim 17, wherein said indicating means include a light emitting diode mounted to said casing.

19. The fill valve assembly according to claim 13, further comprising a power source unit housed in said casing.

20. The fill valve assembly according to claim 19, wherein said power source unit includes a battery.
